(19) United States
(12) Patent Application Publication
(10) Pub. No.: US 2006/0096307 A1
(43) Pub. Date: May 11, 2006

(54) Chemical delivery system for condensate drainage pipe

(76) Inventor: Gregory Coogle, Pembroke Pines, FL (US)

Correspondence Address: YI LI, CUSPA TECHNOLOGY LAW ASSOCIATES, 11820 SW 107 AVENUE, MIAMI, FL, 33176, US

(21) Appl. No.: 10/990,685

(22) Filed: Nov. 16, 2004

Related U.S. Application Data
(63) Continuation-in-part of application No. 10/982,573, filed on Nov. 5, 2004.

(51) Int. Cl. F25D 21/00; F25D 3/02; F16L 5/00

(52) U.S. Cl. 62/272; 62/318

(57) ABSTRACT

A chemical delivery system for inhibiting growth in condensate drainage pipe of an air conditioner includes a reservoir body having an open upper end, an opposing open lower end and a central cavity; an inlet tubular connector mounted perpendicularly to the reservoir body adjacent to the open upper end of reservoir body; an outlet tubular connector mounted perpendicularly to the reservoir body between the inlet tubular connector and the lower end of the reservoir body; a liquid level sensor disposed within the outlet tubular connector; a tubular cleaning spout having one end mounted perpendicularly to the reservoir body opposing the inlet tubular connector, an opposing spout opening, and a removable spout cap; a removable top cap; and a bottom cap removably connected to the open lower end of the reservoir body; thereby closing the central cavity for receiving a grown inhibiting chemical.

### CROSS-REFERENCE TO RELATED APPLICATION

This application is a continuation-in-part of patent application Ser. No. 10/982,573, filed Nov. 5, 2004, which is incorporated herein by reference in their entireties.

### FIELD OF THE INVENTION

The present invention relates to a chemical delivery system for maintaining the condensate drainage pipes of an air conditioner, which dispenses chemicals to inhibit microbial growth.

### BACKGROUND OF THE INVENTION

The condensation of water in air conditioning equipments requires the constant collection and disposal of water through condensate drainage pipes or lines. The water standing still encourages the growth of microbials, such as algae, bacteria and other organisms that clog the pipes. A few designs for delivering chemicals into condensate drainage pipe have been designed in the past. However, many of them either are too complex, or not adequate for solving the problems.

It is desirable to have an improved chemical delivery system suitable for dispensing growth control chemicals, either liquid or solid, over time to the condensate drainage pipe, providing early sensing of clogging to prevent over flow of the condensate drain tray, and for providing access to the condensate drainage pipe for cleaning.

### SUMMARY OF THE INVENTION

In one embodiment, the present invention is directed to a chemical delivery system for inhibiting growth in condensate drainage pipe of an air conditioner, which comprises an elongated reservoir body having an open upper end, an opposing open lower end and a central cavity; an inlet tubular connector having a first end mounted perpendicularly to the reservoir body adjacent to the open upper end of reservoir body, and an inlet connection means at a second open end for connecting to an upstream condensate drainage pipe of an air conditioner; an outlet tubular connector having a first end mounted perpendicularly to the reservoir body between the inlet tubular connector and the lower end of the reservoir body, and an outlet connection means at a second open end for connecting to a downstream condensate drainage pipe; a top cap removably connected to the open upper end of the reservoir body; and a bottom cap removably connected to the open lower end of the reservoir body, thereby closing the central cavity for receiving a grown inhibiting chemical. The chemical delivery system further comprises the growth inhibiting chemical in the central cavity, the growth inhibiting chemical is released over time to the downstream condensate drainage pipe with the condensate water through the outlet tubular connector.

Furthermore, the chemical delivery system also comprises a liquid level sensor having a sensing portion disposed within the outlet tubular connector between the first and second ends of the outlet tubular connector, a connection portion outside of the outlet tubular connector for connecting to a control system, wherein if the downstream condensate drainage pipe is clogged, the liquid level sensor senses an increase of a level of the drainage water, and sends signal to the control system prior to the level of the drainage water raises up to the upstream condensate drainage pipe.

In a further embodiment, the present invention provides a method of prevention of over flow of a condensate drain tray of an air conditioner. The method comprises the steps of: providing a chemical delivery system of the present invention described above; connecting the inlet tubular connector to the upstream condensate drainage pipe of the air conditioner; and connecting the outlet tubular connector to the downstream condensate drainage pipe of the air conditioner; connecting the liquid level sensor to the control system; closing the open lower end with the bottom cap, and closing the open upper end by the top cap; sensing the level of the condensate water in the downstream condensate drainage pipe and sending the signal to the control system, prior to the level of the condensate water raises up to the upstream condensate drainage pipe; and stopping operation of the air condition prior to the condensate water over flowing in the condensate drain tray.

In another embodiment, the chemical delivery system of the present invention further comprises a tubular cleaning spout having one end mounted perpendicularly to the reservoir body opposing the inlet tubular connector, an opposing spout opening, and a spout cap removable connected to the spout opening. Additionally, the chemical delivery system can also comprises a cleaning brush including a brush head and a flexible long stem, for cleaning the upstream condensate drainage pipe through the tubular cleaning spout.

In yet a further embodiment, the present invention provides a method of maintaining a condensate drainage pipe of an air conditioner. The method comprises the steps of: providing a chemical delivery system of the present invention, which comprises a tubular cleaning spout described above; connecting the inlet tubular connector to the upstream condensate drainage pipe of the air conditioner; and connecting the outlet tubular connector to the downstream condensate drainage pipe of the air conditioner; closing the open lower end with the bottom cap; adding the growth control chemical into the central cavity through the open upper end of the reservoir body; then closing the open upper end by the top cap; wherein the growth inhibiting chemical releases over time to the downstream condensate drainage pipe with a condensate water through the outlet tubular connector to prevent a growth of microbial in the downstream condensate drainage pipe; and cleaning the upstream condensate drainage pipe as needed by opening the spout cap and inserting a brush into the upstream condensate drainage pipe through the tubular cleaning spout and the inlet tubular connector.

Additionally, the chemical delivery systems of the present invention can further comprise a basket removably disposed within the central cavity. The basket can be used to hold solid chemicals, such as tablets, and collect debris coming down from the upstream drainage pipe.

In an additional embodiment, with the use of the basket, the chemical delivery system can have a closed lower end of the reservoir body.

### BRIEF DESCRIPTION OF THE DRAWINGS

FIG. 1 is a perspective view of a chemical delivery system of one embodiment of the present invention.

FIG. 2 is a partial sectional view of the chemical delivery system of FIG. 1.

FIG. 3 is a perspective view of a chemical delivery system of a further embodiment of the present invention.

FIG. 4 is a partial sectional view of the chemical delivery system of FIG. 3.

FIG. 5 is a perspective view of a chemical delivery system of another embodiment of the present invention.

FIG. 6 is a partial sectional view of the chemical delivery system of FIG. 5.

FIG. 7 shows a brush which can be used for cleaning the chemical delivery system shown in FIG. 5.

FIG. 8 is a perspective view of a basket of a chemical delivery system of a further embodiment of the present invention.

### DETAILED DESCRIPTION OF THE INVENTION

In one embodiment, the present invention provides a chemical delivery system for controlling microbial growth in drainage pipe of an air conditioner.

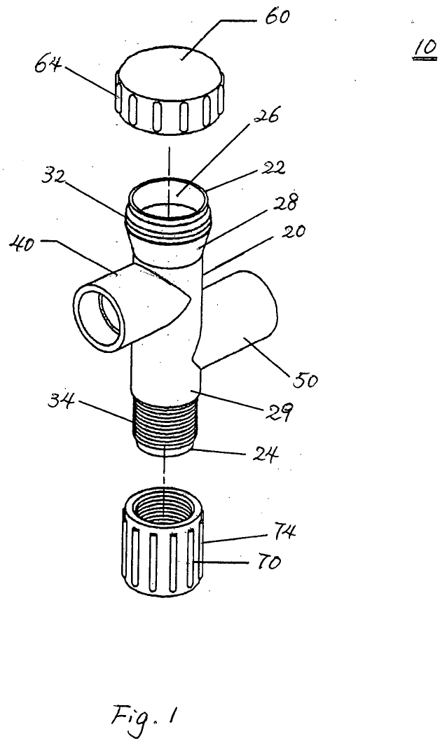

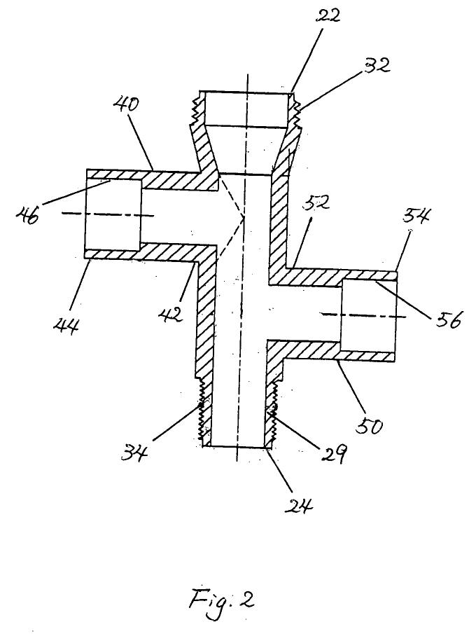

Referring now to FIGS. 1-2, chemical delivery system 10 comprises an elongated reservoir body 20, an inlet tubular connector 40, an outlet tubular connector 50, a top cap 60 and a bottom cap 70.

As shown, elongated reservoir body 20 has an open upper end 22, an opposing lower end 24 and a central cavity 26. In a preferred embodiment as shown in FIG. 1, reservoir body 20 has an enlarged upper portion 28 to form a funnel shape at open upper end 22. The funnel shape structure facilitates addition of a liquid chemical, such as chlorine, into central cavity 26. Furthermore, reservoir body 20 has connection means adjacent to open upper and lower ends 22, 24 for connection with top and bottom caps 60, 70. In the embodiment shown in FIG. 1, reservoir body 20 has a first external thread 32 adjacent to open upper end 22, and a second external thread 34 adjacent to open lower end 24 for thread connections with top and bottom caps 60, 70. It should be understood that other suitable connection means providing a fluid tight connection between the reservoir body and the caps can also be used for the purpose of the present invention.

Inlet tubular connector 40 has a first end 42 mounted perpendicularly to reservoir body 20 adjacent to open upper end 22, and connection means 46 at a second open end 44 for connecting to an upstream condensate drainage pipe. Inlet tubular connector 40 is in fluid communication with central cavity 26.

Outlet tubular connector has a first end 52 mounted perpendicularly to reservoir body 20 between inlet tubular connector 40 and open lower end 24 of reservoir body 20, and connection means 56 at a second open end 54 for connecting to a downstream condensate drainage pipe. Outlet tubular connector 50 is in fluid communication with central cavity 26.

Top cap 60 and bottom cap 70 are removably connected to open upper end 22 and open lower end 24 of reservoir body 20, respectively. As shown in FIG. 1, bottom cap 70 is connected to reservoir body 20 through a thread connection between an internal thread 62 and the second external thread 34 of reservoir body 20, thereby closing lower end 24 for receiving a grown inhibiting chemical therein. Upon disposing a growth inhibit chemical in the central cavity 26, lower portion 29 of reservoir body 20 becomes a chemical reservoir for the downstream drainage pipe. Top cap 60 is also connected to reservoir body 20 through a thread connection between an internal thread (not shown) and the first external thread 32 of reservoir body 20. Top cap 60 is removed to deposit growth inhibiting chemicals through open upper end 22 and also for cleaning purposes.

Preferably, on the external periphery of the top and bottom caps 60, 70 there are gripping assistant means to help the user to grip the cap. As shown in FIG. 1, gripping assistant means are a plurality of protruding ridges 64 and 74 along the external periphery of the cap. Alternatively, the gripping assistant means can also be a plurality of grooves, or other suitable means.

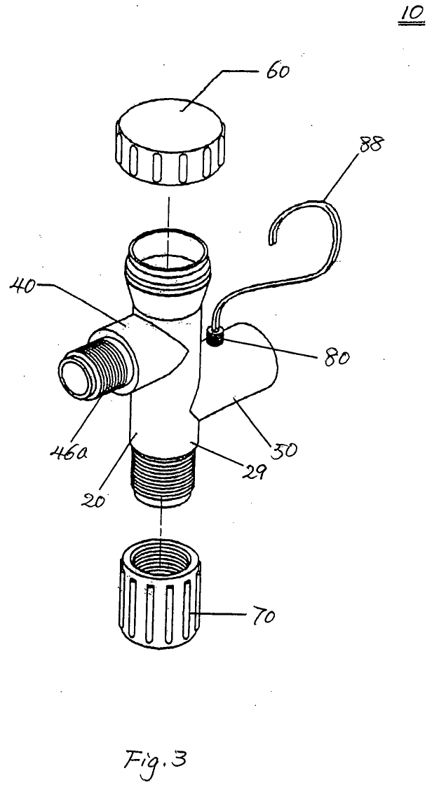

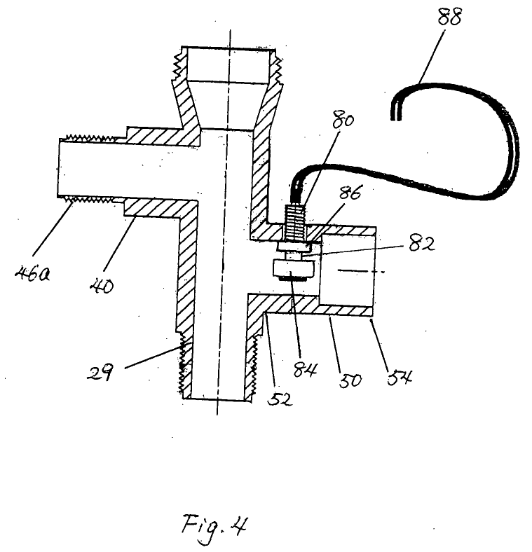

Furthermore, the chemical delivery system 10 of the present invention can further include a liquid level sensor 80 disposed in outlet tubular connector 50 for sensing water level increase caused by clogging of the downstream condensate drainage pipe. As shown in FIGS. 3 and 4, liquid level sensor 80 has a sensing portion disposed within outlet tubular connector 50 between first end 52 and second end 54 and a connection portion 88 outside of outlet tubular connector 50 for connecting to a control system.

In the embodiment shown in FIGS. 3 and 4, liquid level sensor 80 is a float sensor which includes a float 84 connected to the bottom of a stem 82, and a stop 86 disposed above float 84. When the water level increases due to clogging of the downstream condensate drainage pipe, float 84 lifts up along stem 82, causing engagement of two magnets embedded in float 84 and stem 82, which triggers a control system. The control system then can shut down the air conditioner, prior to the water level even arising to the level of the upstream condensate drainage pipe. Therefore, the chemical delivery system of the present invention provides an early notice to the control system before the condensate water back up to the condensate drain tray, and prevents damage of the air conditioning system. In addition to the float sensor, other suitable liquid level sensors can also be used for the chemical delivery system of the present invention.

It should be understood that the early sensing clogging of the condensate drainage pipe is very important to the consumers. Currently, the float sensor is installed in the drainage pipe which only has one level. By the time the float sensor senses the water level increase, the water level also arises in the condensate drain tray to a hazardous level. Using the chemical delivery system of the present invention which has the float sensor located at a substantially lower level than that of condensate drain tray, when the sensor senses the clogging, the water level is still substantially lower than condensate drain tray. Therefore, the instant structure and alert mechanism provide an early prevention of over flow of the condensate drain tray.

In the embodiments shown in FIGS. 1 and 2, connection means 46 and 56 at second open ends 44 and 45 of inlet and outlet tubular connectors 40 and 50 are an internal enlarged tubular section as a female receiver to the upstream and downstream condensate drainage pipes. The upstream and downstream condensate drainage pipes can be inserted into, and sealed by glue to, connection means 46 and 56, respectively. FIGS. 3 and 4 show that the connection means can also have other structures, such as a male thread 46a, which can be connected to the condensate drainage pipe by a thread connection. Moreover, other suitable connections providing a fluid tight connection can also be used for the purpose of the present invention.

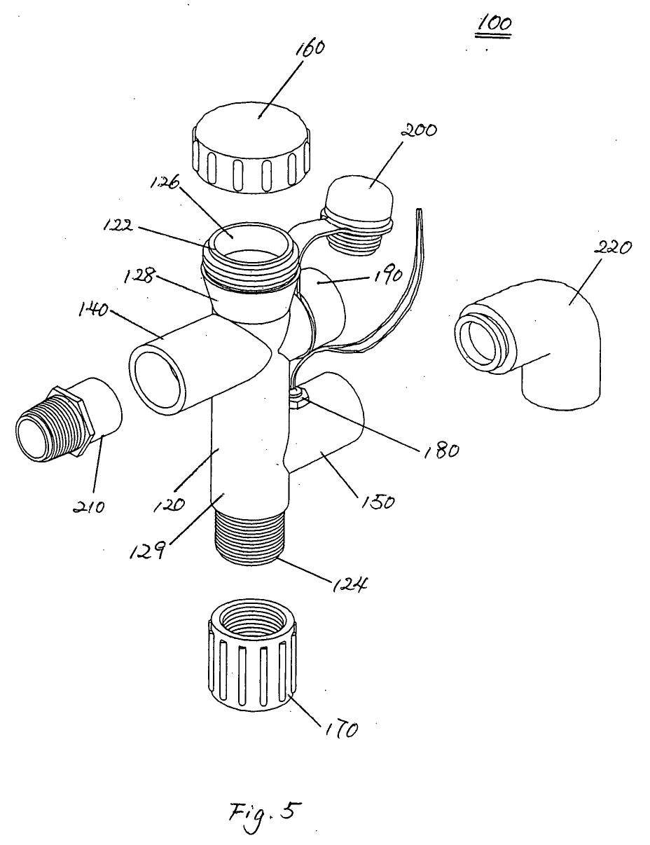

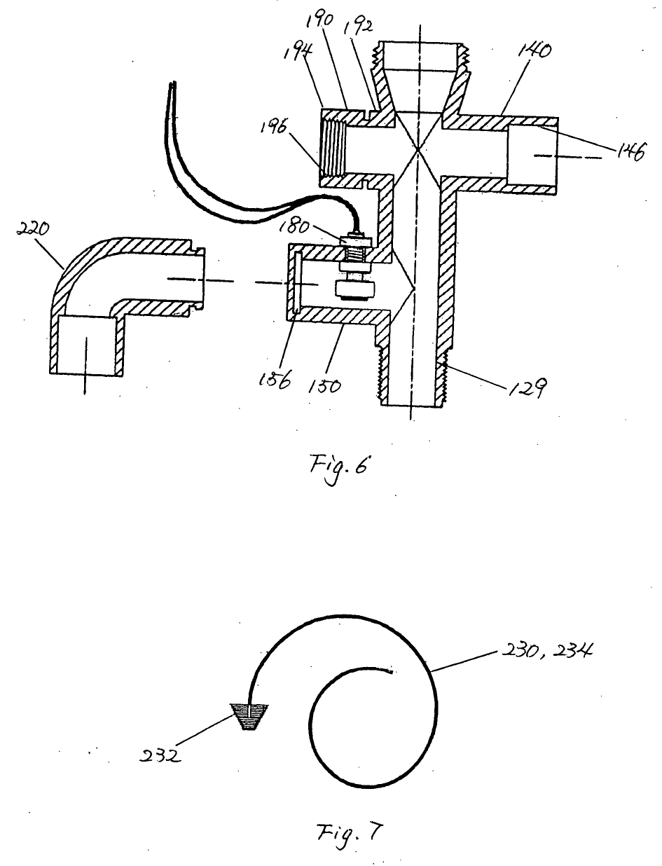

In a further embodiment, the present invention provides a chemical delivery system 100 as shown in FIGS. 5-6. Similar to chemical delivery system 10 described above, chemical delivery system 100 comprises an elongated reservoir body 120, an inlet tubular connector 140, an outlet tubular connector 150, a top cap 160 and a bottom cap 170.

It is noted that the structures of inlet tubular connector 140, outlet tubular connector 150, top cap 160, bottom cap 170, and water level sensor 180 are the same as the corresponding components of chemical delivery system 10 described above.

As shown in FIGS. 5 and 6, elongated reservoir body 120 has an open upper end 122, an opposing lower end 124 and a central cavity 126. Preferably, reservoir body 120 also has an enlarged upper portion 128 to form a funnel shape at open upper end 122. Inlet tubular connector 140 and outlet tubular connector 150 are mounted to reservoir body 120 in the same manner and locations as inlet and outlet tubular connectors 40 and 50 to reservoir body 20 described previously. In addition, chemical delivery system 100 further comprises a tubular cleaning spout 190. Tubular cleaning spout 190 has one end 192 mounted perpendicularly to reservoir body 190 opposing inlet tubular connector 140, an opposing spout opening 194, and a spout cap 200 removably connected to spout opening 194. As shown in FIG. 6, tubular cleaning spout 190 has a connection means 196 at spout opening 194 for connecting spout cap 200 to spout opening 194. Other suitable connection means can also be used for the same purpose.

In the presence of tubular cleaning spout 190, the user or an air conditioner maintenance personnel can assess the upstream condensate drainage pipe for maintenance cleaning. As shown in FIG. 7, a brush 230 which includes a brush head 232 and a flexible long stem 234 can be used for cleaning the upstream condensate drainage pipe through tubular cleaning spout 190 and inlet tubular connector 14. If a severe clogging occurs in the upstream drainage pipe, other suitable tools, such a snake, can be used in a similar manner.

FIGS. 5 and 6 also show that outlet tubular connector 150 can have a connection means 156 which can be connected to a swivel 220. Swivel 220 provides flexibility of positioning the downstream condensate drainage pipe. Also as shown, the female connection means 146 of inlet tubular connector 140 can be connected to a gender changer 210. The gender changer 210 allows the user to connect an upstream condensate drainage pipe which has a female thread to inlet tubular connector 140 which does not have a built-in thread structure.

The chemicals that can be placed in chemical delivery systems 10 and 100 include liquid and solid forms of antimicrobials. Growth control tablets, such as Frost King Pan-Tablets manufactured by Thermwell Products, Co., Inc., New Jersey, can be conveniently dropped into the central cavity. If the antimicrobial placed in the chemical delivery system is solid tablets, it dissolves gradually. The antimicrobial in the chemical delivery system will enter into downstream condensate drainage pipe over time, which controls the growth of microbials, particularly algae, in the downstream condensate drainage pipe. A concentrate liquid form antimicrobial will also enter the downstream condensate drainage pipe over time, instead of flushing away as in a straight pipe line. Therefore, the instant chemical delivery system provides a time release mechanism for dispensing a small amount of antimicrobials for long term control and maintenance.

Any insoluble material from the tablet is accumulated inside bottom cap 70, or 170, and can be easily cleaned by removing the bottom cap. Debris coming down from the upstream can also be cleaned out in the same manner.

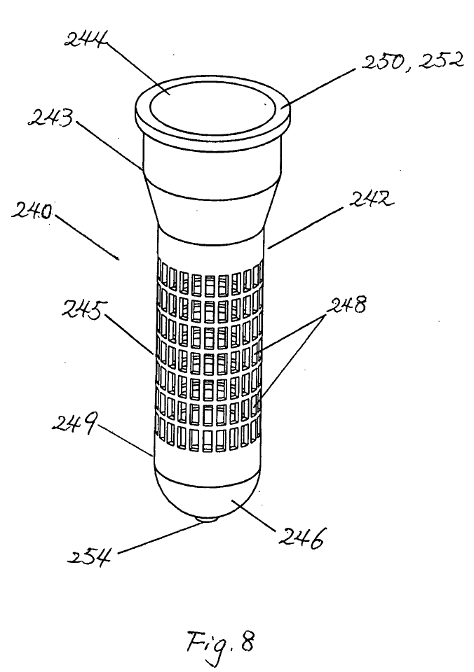

In yet a further embodiment, the chemical delivery systems 10 and 100 described above can further comprise a basket 240 which is disposed within central cavity 26 or 126. As shown in FIG. 8, basket 240 has an elongated basket body 242 which has an open upper end 244, a closed lower end 246, and a plurality of apertures 248 disposed around a middle portion 245 of elongated basket body 242. Basket 240 has a height approximate to the height of central cavity 26, or 126 to be situated therein.

Preferably, middle portion 245 is more than one third of the total length of elongated basket body 242. Upon disposed within central cavity 26 or 126, the lower part of middle portion 245 extends vertically below outlet tubular connector 50, or 150, and the upper part of middle portion 245 extends vertically above inlet tubular connector 40, or 140. Hence the condensate water in the upstream drainage pipe flows into basket 240 through apertures 248, therein it is in fluid communication with the downstream drainage pipe. Preferably, upper portion 243 of elongated basket body 242 is enlarged and configured in a funnel shape, similar to upper portion 28, or 128 of reservoir body 20, or 120, for facilitating addition of liquid chemicals. When basket 240 is used, the chemical tablets can be placed into the basket, wherein the tablets dissolve slowly and release into the downstream drainage pipe with the condensate water.

Furthermore, basket 240 can have retainer means 250 to maintain the vertical position of basket 240 within central cavity 26, or 126. In the embodiment shown in FIG. 8, retainer means 250 is a periphery flange 252 around open upper end 244. When basket 240 is put into central cavity 26, or 126, periphery flange 252 sits on top of open upper end 22 or 122 of elongated reservoir body 20, or 120, which facilitates removal of basket 240 from the chemical delivery systems for cleaning, or refill.

Preferably, the outer diameter of elongated basket body 242 is complementary to the inner diameter of elongated reservoir body 20, or 120 to provide a tight surface contact between lower portion 249 of elongated basket body 240 and lower portion 29, or 129 of elongated reservoir body 20, or 120. The tight surface contact functions to prevent debris from the upstream drainage pipe falling between basket 240 and low portion 29 or 129 of elongated reservoir body 20, or 120. Instead, the debris enters into basket 240 through apertures 248, and descends down to closed lower end 224. When needed, the user can take out basket 240 through open upper end 22, or 122 to discard debris accumulated inside and to clean basket 240. This can be used for frequent maintenance cleaning, instead of opening bottom cap 70 or 170 to drain out everything from open lower end 24 or 124.

In additional embodiment, when basket 240 is used, elongated reservoir body 20, or 120 can have a closed lower end (not shown), since the debris can be cleaned out using the basket as described above. Furthermore, optionally, basket 240 can further comprise a nipple 254 protruding from closed lower end 246, for preventing closed lower end 246 sticking on to the interior surface of the closed lower end by the debris.

Reservoir bodies, inlet and outlet tubular connectors, tubular cleaning spout, top, bottom and spout caps, and basket are preferably injection molded of a plastic material, such as polyethylene, polyvinyl chloride (PVC), and polyamide.

The invention has been described with reference to particularly preferred embodiments. It will be appreciated, however, that various changes can be made without departing from the spirit of the invention, and such changes are intended to fall within the scope of the appended claims. While the present invention has been described in detail and pictorially shown in the accompanying drawings, these should not be construed as limitations on the scope of the present invention, but rather as an exemplification of preferred embodiments thereof. It will be apparent, however, that various modifications and changes can be made within the spirit and the scope of this invention as described in the above specification and defined in the appended claims and their legal equivalents. All patents and other publications cited herein are expressly incorporated by reference.

I claim:

1. A chemical delivery system for inhibiting growth in condensate drainage pipe of an air conditioner, comprising:
an elongated reservoir body having an open upper end, an opposing open lower end and a central cavity;
an inlet tubular connector having a first end mounted perpendicularly to said reservoir body adjacent to said open upper end of reservoir body, and an inlet connection means at a second open end for connecting to an upstream condensate drainage pipe of an air conditioner;
an outlet tubular connector having a first end mounted perpendicularly to said reservoir body between said inlet tubular connector and said open lower end of said reservoir body, and an outlet connection means at a second open end for connecting to a downstream condensate drainage pipe;
a top cap removably connected to said open upper end of said reservoir body; and
a bottom cap removably connected to said open lower end of said reservoir body, thereby closing said open lower end for receiving a grown inhibiting chemical.

2. The chemical delivery system of claim 1 further comprising said growth inhibiting chemical in said central cavity, said growth inhibiting chemical is released over time to said downstream condensate drainage pipe with a condensate water through said outlet tubular connector.

3. The chemical delivery system of claim 1, wherein said open upper end of said reservoir body has a funnel shape for facilitating addition of a liquid chemical into said central cavity.

4. The chemical delivery system of claim 1, wherein said elongated reservoir body has a first external thread adjacent to said open upper end for a thread connection with an internal thread of said top cap, and has a second external thread adjacent to said open lower end for a thread connection with an internal thread of said bottom cap.

5. The chemical delivery system of claim 1 further comprising a basket removably disposed within said central cavity.

6. A chemical delivery system for inhibiting growth in condensate drainage pipe of an air conditioner, comprising:
an elongated reservoir body having an open upper end, an opposing open lower end and a central cavity;
an inlet tubular connector having a first end mounted perpendicularly to said reservoir body adjacent to said open upper end of reservoir body, and an inlet connection means at a second open end for connecting to an upstream condensate drainage pipe of an air conditioner;
an outlet tubular connector having a first end mounted perpendicularly to said reservoir body between said inlet tubular connector and said open lower end of said reservoir body, and an outlet connection means at a second open end for connecting to a downstream condensate drainage pipe;
a liquid level sensor having a sensing portion disposed within said outlet tubular connector between said first and second ends of said outlet tubular connector, a connection portion outside of said outlet tubular connector for connecting to a control system;
a top cap removably connected to said open upper end of said reservoir body; and
a bottom cap removably connected to said open lower end of said reservoir body;
wherein when said downstream condensate drainage pipe is clogged, said liquid level sensor senses an increase of a level of condensate water, and sends a signal to said control system prior to said level of said condensate water raises up to said upstream condensate drainage pipe.

7. The chemical delivery system of claim 6 further comprising said growth inhibiting chemical in said central cavity, said growth inhibiting chemical is released over time to said downstream condensate drainage pipe with a condensate water through said outlet tubular connector.

8. The chemical delivery system of claim 6, wherein said open upper end of said reservoir body has a funnel shape for facilitating addition of a liquid chemical into said central cavity.

9. The chemical delivery system of claim 6, wherein said elongated reservoir body has a first external thread adjacent to said open upper end for a thread connection with an internal thread of said top cap, has a second external thread adjacent to said open lower end for a thread connection with an internal thread of said bottom cap.

10. The chemical delivery system of claim 6 further comprising a basket removably disposed within said central cavity.

11. A method of prevention of over flow of a condensate drain tray of an air conditioner, comprising the steps of:
(a) providing a chemical delivery system of claim 6;
(b) connecting said inlet tubular connector to said upstream condensate drainage pipe of said air conditioner; and connecting said outlet tubular connector to said downstream condensate drainage pipe of said air conditioner;
(c) connecting said liquid level sensor to said control system;
(d) closing said open lower end with said bottom cap, and closing said open upper end by said top cap;
(e) sensing said level of said condensate water in said downstream condensate drainage pipe and sending said signal to said control system, prior to said level of said condensate water raises up to said upstream condensate drainage pipe; and
(f) stopping operation of said air condition prior to said condensate water over flowing in said condensate drain tray.

12. A chemical delivery system for inhibiting growth in condensate drainage pipe of an air conditioner, comprising: an elongated reservoir body having an open upper end, an opposing open lower end and a central cavity;
an inlet tubular connector having a first end mounted perpendicularly to said reservoir body adjacent to said open upper end of reservoir body, and an inlet connection means at a second open end for connecting to an upstream condensate drainage pipe of an air conditioner;
an outlet tubular connector having a first end mounted perpendicularly to said reservoir body between said inlet tubular connector and said open lower end of said reservoir body, and an outlet connection means at a second open end for connecting to a downstream condensate drainage pipe;
a tubular cleaning spout having one end mounted perpendicularly to said reservoir body opposing said inlet tubular connector, an opposing spout opening, and a spout cap removable connected to said spout opening;
a top cap removably connected to said open upper end of said reservoir body; and
a bottom cap removably connected to said open lower end of said reservoir body, thereby closing said open lower end for receiving a grown inhibiting chemical.

13. The chemical delivery system of claim 12 further comprising a liquid level sensor having a sensing portion disposed within said outlet tubular connector between said first and second ends of said outlet tubular connector, a connection portion outside of said outlet tubular connector for connecting to a control system; wherein if said downstream condensate drainage pipe is clogged, said liquid level sensor senses an increase of a level of said drainage water, and sends signal to said control system prior to said level of said drainage water raises up to said upstream condensate drainage pipe.

14. The chemical delivery system of claim 12 further comprising said growth inhibiting chemical in said central cavity, said growth inhibiting chemical is released over time to said downstream condensate drainage pipe with a condensate water through said outlet tubular connector.

15. The chemical delivery system of claim 12, wherein said open upper end of said reservoir body has a funnel shape for facilitating addition of a liquid chemical into said central cavity.

16. The chemical delivery system of claim 12, wherein said elongated reservoir body has a first external thread adjacent to said open upper end for a thread connection with an internal thread of said top cap, has a second external thread adjacent to said open lower end for a thread connection with an internal thread of said bottom cap.

17. The chemical delivery system of claim 12 further comprising a basket removably disposed within said central cavity.

18. The chemical delivery system of claim 12 further comprising a cleaning brush including a brush head and a flexible long stem, for cleaning said upstream condensate drainage pipe through said tubular cleaning spout.

19. A method of maintaining a condensate drainage pipe of an air conditioner, comprising the steps of:
(a) providing a chemical delivery system of claim 12;
(b) connecting said inlet tubular connector to said upstream condensate drainage pipe of said air conditioner; and connecting said outlet tubular connector to said downstream condensate drainage pipe of said air conditioner;
(c) closing said open lower end with said bottom cap;
(d) adding said growth control chemical into said central cavity through said open upper end of said reservoir body; then closing said open upper end by said top cap; wherein said growth inhibiting chemical releases over time to said downstream condensate drainage pipe with a condensate water through said outlet tubular connector to prevent a growth of microbial in said downstream condensate drainage pipe; and
(e) cleaning said upstream condensate drainage pipe as needed by opening said spout cap and inserting a cleaning means into said upstream condensate drainage pipe through said tubular cleaning spout and said inlet tubular connector.

20. A chemical delivery system for inhibiting growth in condensate drainage pipe of an air conditioner, comprising:
an elongated reservoir body having an open upper end, an opposing closed lower end and a central cavity;
an inlet tubular connector having a first end mounted perpendicularly to said reservoir body adjacent to said open upper end of reservoir body, and an inlet connection means at a second open end for connecting to an upstream condensate drainage pipe of an air conditioner;
an outlet tubular connector having a first end mounted perpendicularly to said reservoir body between said inlet tubular connector and said closed lower end of said reservoir body, and an outlet connection means at a second open end for connecting to a downstream condensate drainage pipe;
a basket removably disposed within said central cavity; and
a top cap removably connected to said open upper end of said reservoir body.

21. The chemical delivery system of claim 20 further comprising said growth inhibiting chemical in said central cavity, said growth inhibiting chemical is released over time to said downstream condensate drainage pipe with a condensate water through said outlet tubular connector.

22. The chemical delivery system of claim 20, wherein said open upper end of said reservoir body has a funnel shape for facilitating addition of a liquid chemical into said central cavity.

23. The chemical delivery system of claim 20, wherein said elongated reservoir body has an external thread adjacent to said open upper end for a thread connection with an internal thread of said top cap.

24. The chemical delivery system of claim 20 further comprising a liquid level sensor having a sensing portion disposed within said outlet tubular connector between said first and second ends of said outlet tubular connector, a connection portion outside of said outlet tubular connector for connecting to a control system.
